(19) United States
(12) Patent Application Publication
(10) Pub. No.: US 2008/0135112 A1
(43) Pub. Date: Jun. 12, 2008

(54) Apparatus and Method for Assembling Relief Valve Unit

(76) Inventor: Jin Hyoung Park, Incheon (KR)

Correspondence Address: DITTHAVONG MORI & STEINER, P.C., 918 Prince St., Alexandria, VA, 22314, US

(21) Appl. No.: 11/609,201

(22) Filed: Dec. 11, 2006

(51) Int. Cl. F16K 15/00

(52) U.S. Cl. 137/543.15

(57) ABSTRACT

An approach is provided for minimizing failure of relief valve assembly and enhancing quality of control of making a relief valve conforming to the standards. An improved relief valve includes a body having a seat formed in a passageway. A relief valve core member is mounted in the seat, wherein the body and the relief valve core member are fixedly engaged by spinning the body into a receiving portion of one the relief valve member, wherein the relief valve member is configured to create a resilient force that control the pressure on the passageway.

### FIELD OF THE INVENTION

The present invention relates to a relief valve, and more particularly to a relief valve unit for a pressure cylinder.

### BACKGROUND

Conventional disposable pressure cylinders have been used to contain various kinds of gas (e.g., LP (Liquefied Petroleum) or liquefied petroleum gas mixed with methylacetylene-propadiene gas (called as MAPP gas), etc.). These cylinders include a main valve to control high pressured sources. For safety purposes, safety means are regulated by various agencies such as a Department of Transportation (DOT), a relief valve conforming to the safety standard is inserted into each compressed cylinders.

The relief valve is a type of valve used to control or limit the pressure in a system by allowing the pressure source (e.g., fluid or gas) to flow from an auxiliary passageway, away from the main flow path. The relief valve is designed or set to open at a predetermined pressure to protect pressure vessels and other equipment from being subjected to pressures that exceed their design limits. When a pressure setting is exceeded, the relief valve becomes the path of least resistance as the valve is forced open and a portion of the fluid is diverted through the auxiliary route. The diverted sources (liquid, gas, or liquid-gas mixture) are usually routed through a valve body system via a passageway.

Pressure relief valves are self-actuated safety valves designed to relieve excess pressure upstream from the line. The Compressed Gas Association (CGA) is involved in the development and promotion of safety standards and safe practices in the industrial and medical gas industry. The CGA publishes standards and specifications regarding gas cylinders, equipment, gases, hydrogen, medical, protection and safe handling and pressure relief devices; such standards are widely adopted in the United States and other areas of the world.

Conventionally, a relief valve body consists of threaded portions at which the relief valve body and the relief valve core are firmly engaged. For example, in the assembly line, the valve body and relief valve core are jointly engaged with the threads by screwing the relief valve core down into the body. As an exemplary shown in the FIGS. 7 and 8, shown as backgrounds, the relief valve body includes the threads (e.g., helical ridge) 701 resided inside of the wall of the body. In order for threadly fastening the relief valve core and the body 801, the relief valve core includes a head having grooves or threads 703 formed on outer surface of the head. Also, the head is specially shaped to allow a screwdriver to grip the screw when driving in it. Thus, when assembling, the relief valve core is fastened into the body by using a method that the relief valve core is screwed down until a gasket touches the bottom of relief valve body. As shown in the FIG. 8, the completion of the conventional assembly of the relief valve being disposed into a cylinder is provided.

These conventional systems have certain drawbacks from a manufacturing standpoint. First, leakage of pressured source can be caused by metallic dust or chips brought from screwing process through threads during assembly. Second, it is a challenge to determine and control the insert depth when the relief core is threadly engaged into the relief valve body,

With regard to the first issue, typically, due to a short assembly line cycle time, the relief valve core is inserted by an automatic process in the relief valve body. A revolving screwdriver hangs over the assembly line and when the cylinders are aligned the screw comes down to screw the relief valve core to the valve body by utilizing the threads on both sides. During the process, the slightest imperfection or misalignment can lead to defects. Also, friction created by abrasion of the threads can create micro chips and metallic dusts, thereby preventing the gasket from sealing properly. This causes seepage of gas from the relief valve unit.

As for the second issue, the insertion depth is critical. This is because of the fact that the force constant of the spring disposed in the relief valve core is determined by the insert depth and the constant is related to open the relief valve core to release the pressured source. If the insert depth is too shallow the spring of the relief valve core does not have sufficient force to press the rubber gasket causing the relief valve core to release before reaching to a predetermined pressure level (e.g., 360-450 PSI (Pound-force per Square Inch) set by the CGA). However, if the inserted depth of the relief valve core is too deep, the opening tolerance of the relief valve core increases surpassing the level of releasing.

Moreover, it may not be feasible or nearly impossible to inspect the insert depth of each and every relief valve unit once the assembly is completed. For instance, cylinder manufacturers inspect only two per each assembled 3000 cylinders to meet the DOT regulations. However, the irregularities of insertion depths cannot guarantee that the remaining cylinders are acceptable.

Accordingly, a need exists for providing a relief valve unit that overcomes drawbacks of conventional assembly process.

### SOME EXEMPLARY EMBODIMENTS

These and other needs are addressed by the claimed invention in which an apparatus is provided for minimizing non-conforming relief valve when assembling a relief valve member into a valve body for installation into a cylinder. The claimed apparatus includes a relief valve body in which the relief valve member is engaged without using threads for the engaging, wherein a head of the relief core member is fixedly engaged into the valve body using a spinning process. In the spinning process, the top ends of the valve body can be spun into the inside of grooved belt formed at the circumference of the head of the relief valve member to engage the relief valve core member and the valve body. This arrangement provides an assembly process that is simple and cost-effective, while enhancing the quality control.

According to one aspect of the present invention, a pressure relief device is provided. The device includes a relief valve core member configured to relieve the pressure in response to a predetermined pressure level. The device includes a valve body configured to receive the relief valve core member, wherein the valve body includes a extended opening passageway having a first end, a tube, and a second end, wherein a bottom part of the relief valve core member is positioned at the second end, and the middle part of the relief core member is resided at the tube, wherein the first end of the valve body has a insert portion configured to engage the insert portion into a receiving portion formed at a top part of the relief valve core member. The relief valve core member further includes a valve pin, a spring resides over an outside diameter of the valve pin, a head resides on the first end of the valve body and configured to receive the insert portion formed at the first end, and a gasket configured to engage on the second end, wherein the relief valve core member and the valve body is securely engaged to resiliently compress the pressure through the interaction of the spring and gasket against sealing surface of the second end.

In another aspect of the invention, an apparatus to control a pressure is provided. The apparatus includes a body having a seat formed in a passageway; and a relief valve member mounted in the seat, wherein the body and the relief valve member are fixedly engaged by spinning the body into a receiving portion of the relief valve member, wherein the relief valve member is configured to create a resilient force that control the pressure on the passageway.

The relief valve core member further includes a valve pin; a spring resides over an outside diameter of the valve pin; a head configured to receive the upper part of the valve pin is formed of the receiving portion; and a gasket configured to receive the bottom part of the valve pin, wherein the receiving portion of the head fixedly engaged with the valve body resiliently compresses the pressure through the interaction of the spring and gasket against sealing surface on the passageway.

In yet another aspect of the present invention, a method for assembling a relief valve is disclosed. The method provides determining a body having a seat for receiving a relief valve member and openings for relieving a pressure; assembling a relief valve member according to a predetermined pressure, wherein a spring is disposed outside of a valve pin, a gasket and a head is engaged at each other side of the valve pin; disposing the relief valve member within the seat; engaging the body with the relief valve member, wherein the portions of the body is spun into a engaged portion formed at the head of the relief valve member; placing the engaged relief valve within a housing formed in the cylinder vessel; and sealing the housing.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram showing a sectional front view of a relief valve body in accordance with an embodiment of the present invention;

FIG. 2 is a diagram of a relief valve core member which is engaged into the relief valve body of FIG. 1, in accordance with an embodiment of the present invention;

FIG. 3 is a diagram showing a top and front view of a head of the relief valve core member, in accordance with an embodiment of the present invention;

FIGS. 4A-4C are diagrams showing a spinning process by which the head of the relief core member can be engaged with the relief valve body, in accordance with an embodiment of the present invention;

FIG. 5 is a diagram of an assembled relief valve in which the relief valve core of FIG. 2 is engaged into the relief valve body of the FIG. 1 by using the spinning process, in accordance with an embodiment of the present invention;

FIG. 6A is a sectional front view of the assembled relief valve of FIG. 5 disposed into a cylinder, in accordance with an embodiment of the present invention;

FIG. 6B is a flowchart of a process for assembling relief valve, in accordance with an embodiment of the present invention;

FIG. 7 is a diagram showing a conventional relief valve core member and a relief valve body; and

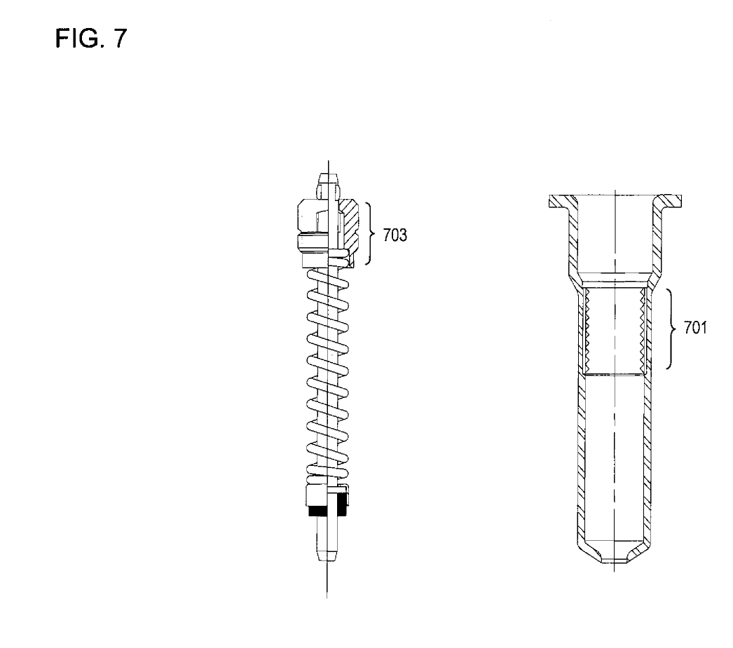

FIG. 8 is a diagram showing a conventionally assembled relief valve into a cylinder.

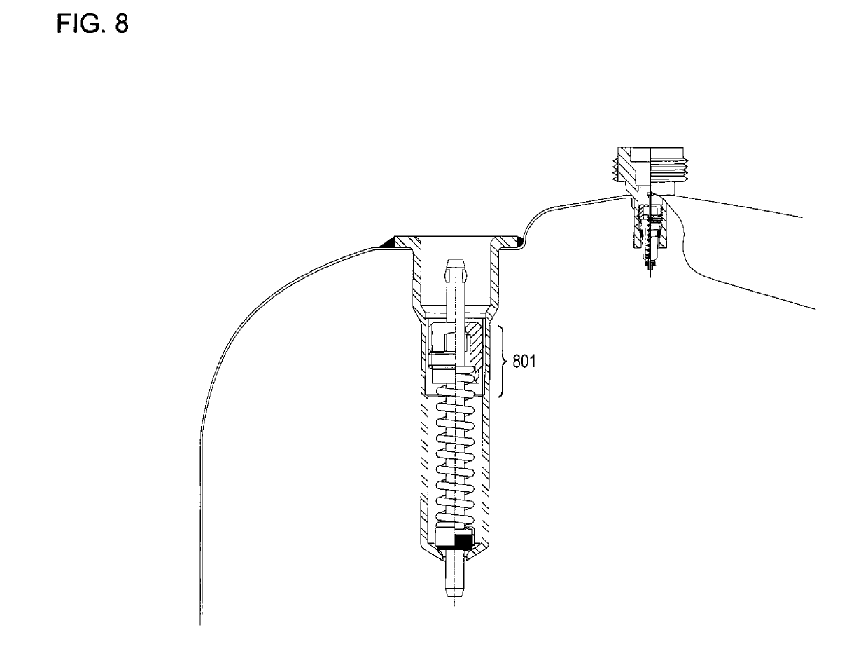

### DESCRIPTION OF THE PREFERRED EMBODIMENT

A device, and method for assembling a relief valve core member into a valve body and the assembled relief valve are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

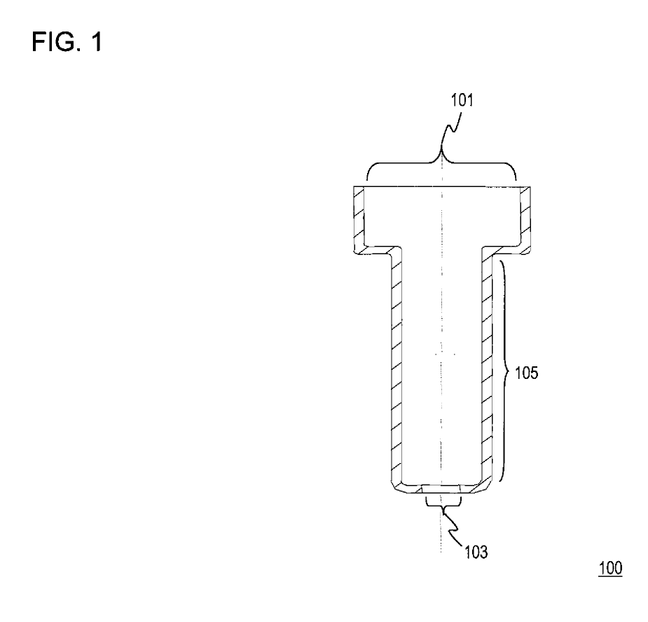

FIG. 1 is a diagram showing a sectional front view of a relief valve body in accordance with an embodiment of the present invention. The valve body 100, which is adapted to be engaged a relief valve core member, includes a first end as an outlet 101, a second end as an inlet 103 and a longitudinal tube 105 configured between the first end 101 and the second end 103. The first end 101, a longitudinal tube 105 and a second end 103 are configured in-line for releasing the pressured source through the outlet 101. In an exemplary embodiment, the valve body can be made of one of brass, cast iron, carbon steel, stainless steel, or synthetic material. The material of body can endure a set pressure and the set pressure for the valve, for example, can range from about 360 to about 450 PSI.

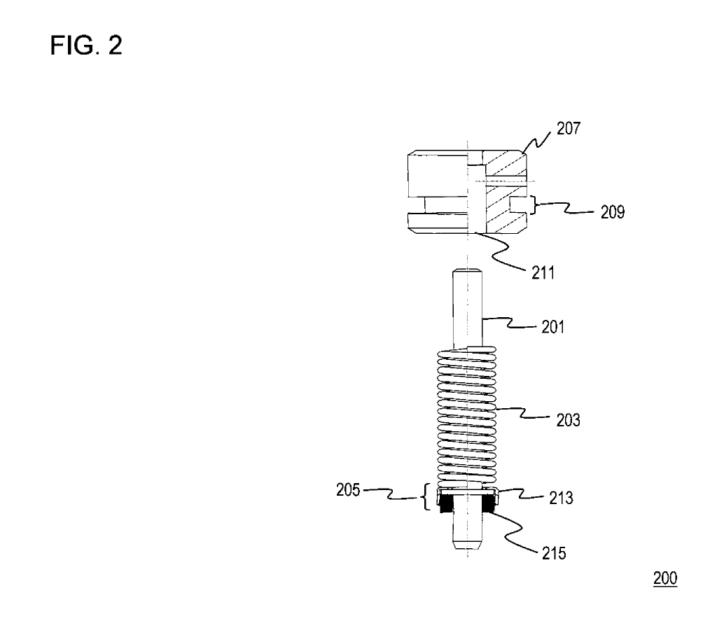

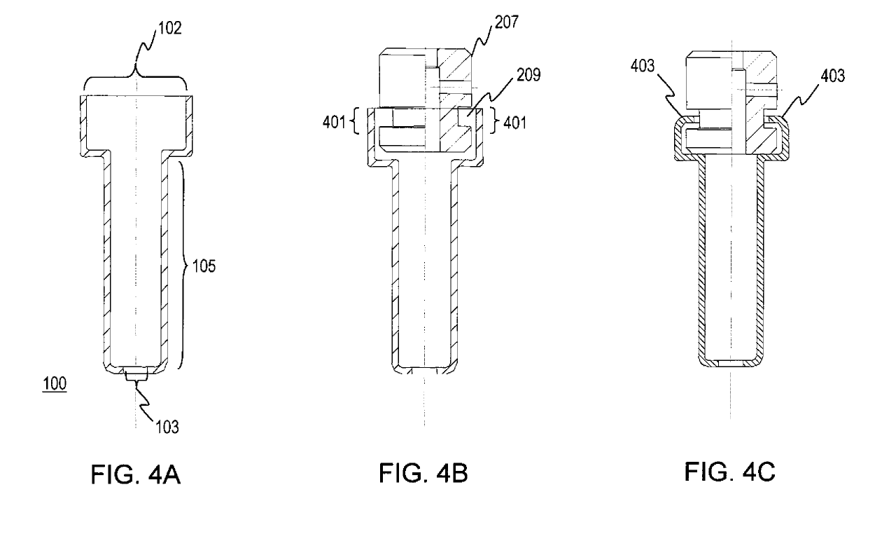

FIG. 2 is a diagram showing a relief valve core member 200, in accordance with an embodiment of the claimed subject matter. The relief valve core member 200 includes a head 207, a valve pin 201, a spring 203 and a rubber gasket 205. In an exemplary embodiment, the valve pin 201 can be made one of brass, cast iron, carbon steel stainless steel, or synthetic material. Diameter of the valve pin 201 can be varied according to a predetermined pressure force. For example, the diameter of the valve pin can be about 1.6 mm-1.8 mm. The spring 203, which is disposed on the outside of the valve pin 201, resides between the head 207 and the rubber gasket 205. The spring 203 pushes the rubber gasket 205 downward against the second end 103 to seal off a seat of the rubber gasket 205. In an embodiment, the rubber gasket 205 includes a cup 213 and a rubber 215 (e.g., natural rubber, hydrin rubber, or neoprene, etc.) disposed inside being covered by the cup 213. The different force constant of the spring 203 can be selected according to a predetermined relief level (e.g., 360-450 PSI). Any biasing mechanisms other than the spring 203 can be applied. According to an exemplary embodiment, the spring 203 can be made of a piano wire. The piano wire can be made from tempered high-carbon steel or brass. Example of materials that may be used as part of the spring include coil of wire, steel or rubber and are not limited to this construction. It is noted that the spring 203 may be any elastic material that works to regain its original shape after being compressed. As shown in the FIG. 2, the head 207 includes a tube 211 disposed inside of the head to receive the valve pin 201. The head 207 also has a grooved belt 209 at the circumference of the head 207 to engage the valve body 100 by using a spinning process shown in the FIG. 4A-4C.

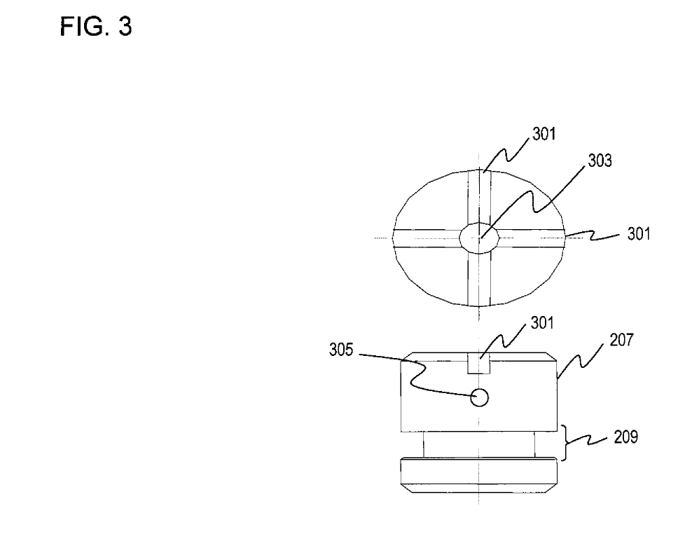

FIG. 3 is a diagram showing a top and front view of a head, one of the relief valve core member, in accordance with an embodiment of the present invention. As shown in the top view, in the middle of the cross, a first hole 303 is disposed for relieving pressured gas to a vertical direction to the head position through passageway made from the second end 103 to the first end 101 when the rubber gasket is opened provided the predetermined level of the force is reached. In the top view of the head 207, cross-head groove (“+” shaped slot) 301 is formed for facilitating to relieve the pressured gas from a second hole 305 that is relieved from a horizontal direction. The relieved gas from the second hole can flow to openings formed at the “+” shaped slot 301 to be relieved through the hole 303. According to an exemplary embodiment, the head 207 can be made of tempered high-carbon steel or brass. In an embodiment, diameter of the head 207 can be about 8.5 mm-9 mm.

FIGS. 4A-4C are diagrams showing a spinning process by which the head of the relief core member can be engaged with the relief valve body, in accordance with an embodiment of the present invention. In this process, the valve body 100 is disposed in the FIG. 4A. In FIG. 4 B, the bottom portion of the head 207 is inserted into the valve body 100 through the first end 101 of the valve body 100. The position of the head 207 is set to receive top portions 401 of the valve body 100 via grooved belt 209. As shown in the FIG. 4C, a spinning process can be achieved by folding the top portions 401 of the vale body 100 and spinning into the inside of the grooved belt 209 formed at the circumference of the head 207. In this process, the head 207 of the relief valve core member 200 and the valve body 100 can be firmly engaged.

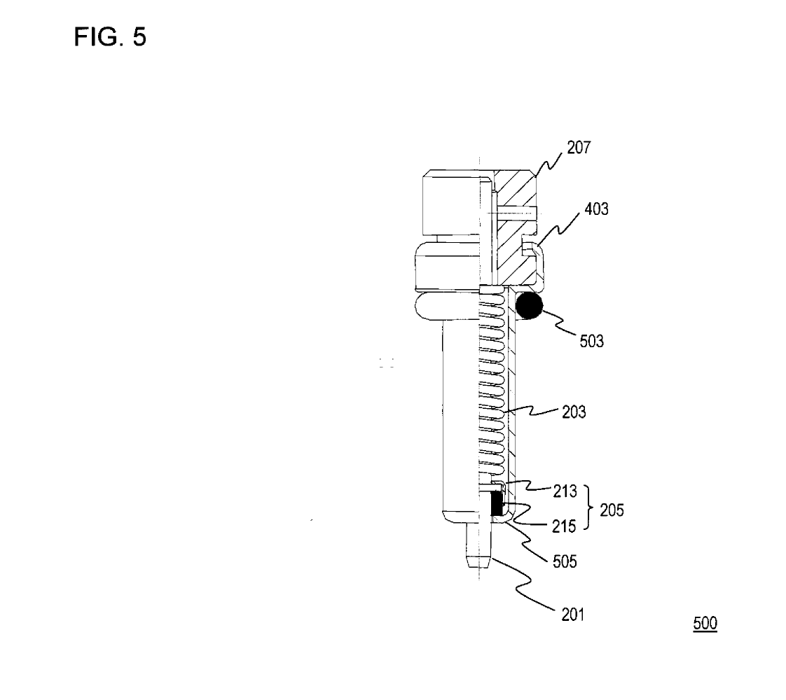

FIG. 5 is a diagram of an assembled relief valve 500 in which the relief valve core of FIG. 2 is engaged into the relief valve body of the FIG. 1 by using the spinning process (FIGS. 4A-4C), in accordance with an embodiment of the present invention. As shown in the FIG. 5, the engaged portion need not include any threads, spikes or grooves outside of the relief valve core member 200. As shown, no threads, spikes or grooves are formed inside of the valve body 100 to allow for engaging the relief valve core member 200. An O-ring 503 is disposed at the bottom of the head in order to seal off spaces on a valve seat where the engaged relief valve 500 is installed into a cylinder.

According to the disclosed spinning process shown in the FIGS. 4A-4C, the grooved belt 209 formed at the circumference of the head 207 allows to simply engage the relief valve core member 200 and the relief valve body 100 by folding the first end 101 of the valve body 100 inside of the grooved portions 209 when assembly. The spinning process causes the head 207 being prevented from easily becoming disengaged from the engaged portion 401. Therefore, the engaged portion 401 allows to sustain resilient force caused by a compressed spring 207 when assembling the relief valve core member 200 into the valve body 100.

According to an embodiment, the second end 103 of the relief valve body 100 defines portions 505 for receiving the rubber gasket 205 (See, FIG. 5) which is placed at the bottom of the relief valve core member 200. As shown in the FIG. 5, the assembled relief valve 500 includes the valve pin 201, the helical spring 207 and the rubber gasket 205. The rubber gasket 205 is disposed at the second end 103 of the valve body 100. According to an embodiment, the rubber gasket 205 includes the rubber portion 215 to be slid into the cup 213 that extends away from an appropriate end of the portion 505 of the valve body 100. The gasket 205 abuts on the portion 505 which bears against the respective compressed force from the compressed spring 203 disposed outside of the valve pin 201 of the relief valve core member 200.

A rubber element 215 of gasket 205 is sealingly engaged against the receiving portions 505 of the valve body 100. When pressure builds up in the relief valve core member 200 and it exceeds a predetermined level, the force is exerted to the rubber gasket 205 and the rubber portion 211 can be opened by the force. At that point, a certain amount of the compressed pressure will be permitted to relieve through the passageways formed in the longitudinal tube 105, first end 101 of the valve body 100 and the circled hole 303 of the head 207. It is noted that the diameter of the longitudinal tube 105 can be determined by the level of predetermined force associated with a size of cylinder. In an exemplary embodiment, the diameter of the longitudinal tube 105 ranges about 4.7 mm-4.9 mm.

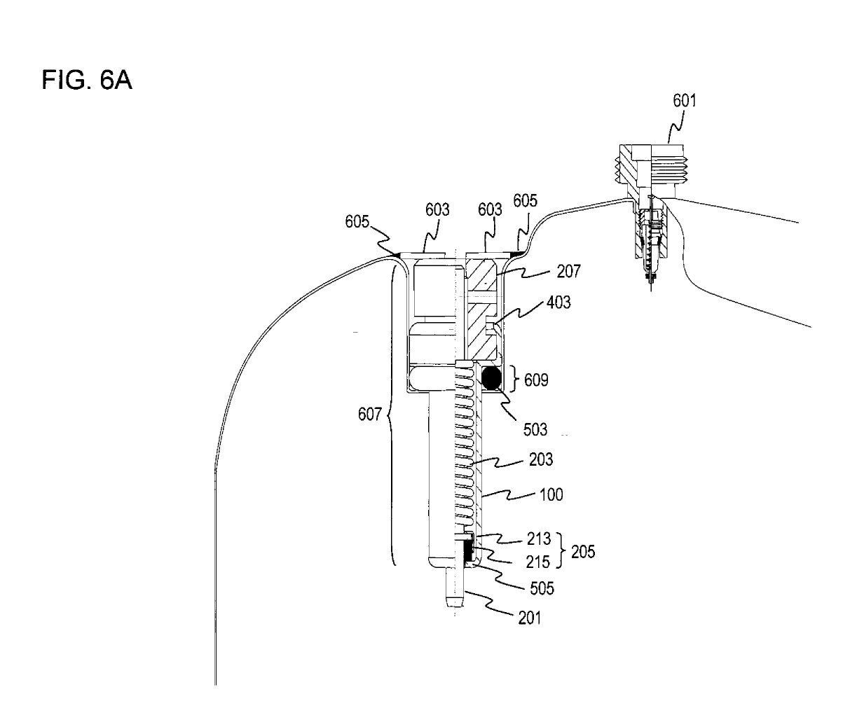

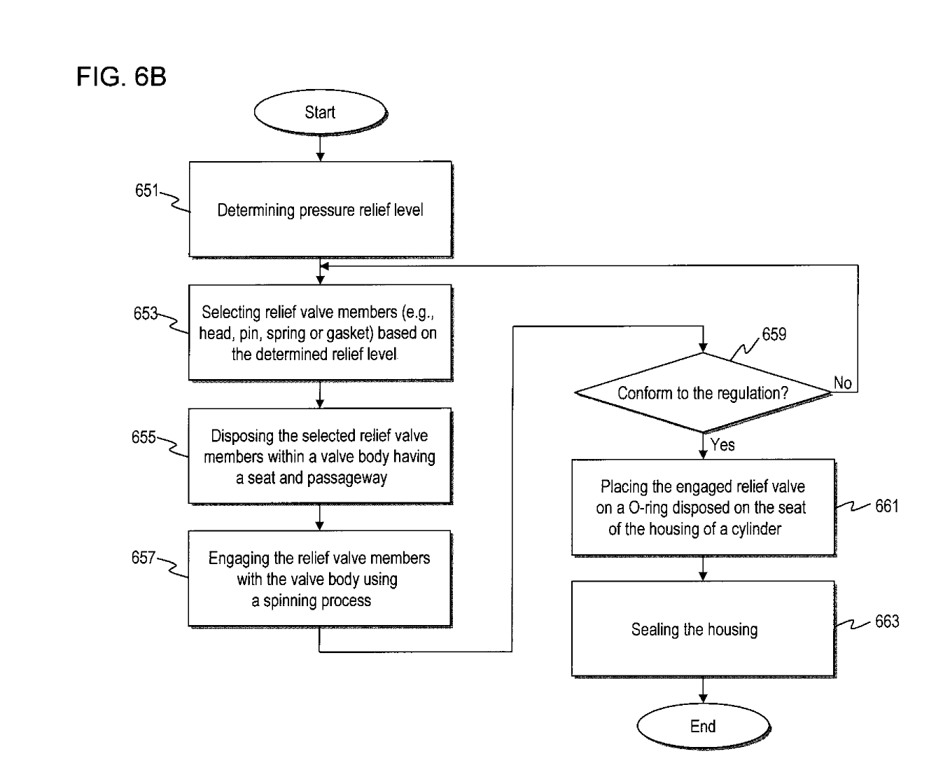

FIG. 6A is a sectional front view of the assembled relief valve 500, as shown in FIG. 5, disposed into a cylinder, in accordance with an embodiment of the present invention. Main valve 601 is disposed on a cylinder chamber. Washer 603 is used to support and to lock the load of the assembled relief valve 500. For the purpose of mechanical seal, for example, a steel washer 603 having a slit in the middle of the washer is disposed on the top of the head 207 to cover the housing 607. It is noted that relieved gas is discharged through the slit. The washer 603 can be metal or plastic. The assembled relief valve 500 is inserted into the housing 607 formed to receive the assembled relief valve 500. In this example, an O-ring seat 609 is defined in the middle portion of the housing. The O-ring 503 is positioned in the O-ring seat 609 to receive and sealingly to engage the assembled relief valve 500 and the housing of the cylinder 607. At that point, the O-ring 503 can be recessed to perform a mechanical seal. The seal is designed to have a point contact between the O-ring 503 and sealing faces. This allows a high local stress, able to contain high pressure, without exceeding the yield stress of the assembled relief valve 500. Namely, the flexible nature of O-ring materials accommodate imperfections in the mounting parts. Generally, the O-ring 503 can be designed to be seated in the O-ring seat 609 and compressed during assembly between the assembled relief valve 500 and the housing 607 of a cylinder, creating a seal at the interface. It is noted that O-rings can be one of the most common seals used in machine design because they are inexpensive and easy to make, reliable, and have simple mounting requirements, however, there can be variations in profile design other than circular.

The soldering, welding or brazing can be used as exemplary methods for the engaging washers 603 on the receiving parts 605 of the cylinder. Soldering can be performed in a number of ways, for example, including passing parts over a small fountain in a bulk container of molten solder (wave soldering), heating assemblies by use of an infrared lamp, or by using a point source such as an electric soldering iron, a brazing torch, or a hot-air soldering tool.

FIG. 6B is a flowchart of assembly of relief valve, in accordance with an embodiment of the present invention. In step 651, a manufacturer (assembler) can determine whether to set a pressure relief level (predetermined pressure relief level). When the level is determined, per step 653, the manufacturer can select proper members of relief valve core based on the desired pressure relief level. The members of the relief valve core includes a head, spring, a valve pin (valve pin) or a gasket. In step 655, the relief valve core member can be disposed within the valve body which has a seat to receive the relief valve core member and passageway openings. Unlike the conventional threaded engaging method, in step 657, the relief valve core members can be engaged with the valve body using a spinning process as shown in the FIG. 5. A tester can test whether the engaged relief valve can conform to the regulation in step 659. If the relief valve passes a certain requirements, the engaged relief valve can be disposed within a seat formed in the housing of a cylinder. The O-ring is positioned on the O-ring seat to receive and to seal spaces between the engaged relief valve and the housing of the cylinder. Per step 663, the housing is sealed off with a washer using soldering or brazing.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A pressure relief device, comprising:
a relief valve core member configured to relieve the pressure in response to a predetermined pressure level; and
a valve body configured to receive the relief valve core member, wherein the valve body includes an extended opening passageway having a seat including a first end, a tube, and a second end, the seat being configured to receive the relief valve core member, wherein the first end of the valve body has a portion configured to be spun into a receiving portion formed at one of the relief valve core member.

2. A device according to claim 1, wherein the relief valve core member includes,
a valve pin,
a spring resides over an outside diameter of the valve pin,
a head resides on the first end of the valve body, and
a gasket configured to seal off on the surface of the second end and to resiliently compress the pressure through the interaction of the spring and gasket against sealing the surface of the second end.

3. A device according to claim 1, wherein the receiving portion formed at one of the relief valve core member includes a head.

4. A device according to claim 2, wherein the receiving portion includes a groove formed at the circumference of the head.

5. A device according to claim 2, wherein the head includes two holes that are formed at the head for relieving the pressure in both vertical and horizontal direction to the pin.

6. A device according to claim 2, wherein the spring can be selected from various force constants during the assembly to adjust a relief pressure level according to a predetermined level of the pressure force ranging from about 360 PSI (Pound-force per Square Inch) to about 450 PSI (Pound-force per Square Inch).

7. A device according to claim 2, wherein the diameter of the head ranging from about 7.0 mm to about 12.0 mm.

8. A device according to claim 2, wherein the diameter of the valve pin ranging from about 1.5 mm to about 1.9 mm.

9. An apparatus to control a pressure, comprising:
a body having a seat formed in a passageway; and
a relief valve member mounted in the seat, wherein the body and the relief valve member are fixedly engaged by spinning the body into a receiving portion of one of the relief valve member, wherein the relief valve core member is configured to create a resilient force that controls the pressure via the passageway.

10. An apparatus according to claim 9, wherein the relief valve core member includes,
a valve pin,
a spring resides over an outside diameter of the valve pin,
a head configured to receive the valve pin, and
a gasket configured to receive the valve pin, wherein the gasket resiliently compresses the pressure through the interaction of the spring and gasket against sealing surface on the passageway.

11. An apparatus according to claim 9, wherein the receiving portion formed at one of the relief valve core member includes a head.

12. An apparatus according to claim 9, wherein the receiving portion includes a groove formed at the circumference of the head, wherein two holes are formed at the head for relieving the pressure in both vertical and horizontal directions to the pin.

13. An apparatus according to claim 10, wherein the spring can be selected from various force constants during the assembly to adjust a relief pressure level according to a predetermined level of the pressure force ranging from about 360 PSI (Pound-force per Square Inch) to about 450 PSI.

14. An apparatus according to claim 10, wherein the diameter of the head ranging from about 7.0 mm to about 12.0 mm.

15. An apparatus according to claim 10, wherein the diameter of the valve pin ranging from about 1.5 mm to about 1.9 mm.

16. A method for assembling a relief valve, the method comprising,
fixing a body having a seat for receiving a relief valve member and an opening for releasing a pressure;
assembling a relief valve member according to a predetermined pressure level, wherein a spring is disposed outside of a valve pin and a gasket and a head is engaged at each other side of the valve pin;
disposing the relief valve member within the seat;
engaging the body with the relief valve member, wherein the portions of the body is spun into an engaged portion formed at the head of the relief valve member;
placing the engaged relief valve within a housing formed in the cylinder vessel; and
sealing the housing.

17. A method according to claim 16, further comprising:
folding the portion of the body and spinning into the engaged portion of the head that has a form at least one of a groove, a slit, a gap, hole, or an opening formed at the head, wherein the body and the relief valve member can be firmly engaged.

18. A method according to claim 16, further comprising:
selecting the spring from various force constants during the assembly to adjust a relief pressure level according to a predetermined level of the pressure force ranges from about 360 PSI (Pound-force per Square Inch) to about 450 PSI.

19. A method according to claim 16, further comprising:
selecting the valve pin having a diameter ranging from about 1.5 mm to about 1.9 mm.
